(19) United States
(12) Patent Application Publication
(10) Pub. No.: US 2011/0128317 A1
(43) Pub. Date: Jun. 2, 2011

(54) CAPACITIVE LOAD DRIVING CIRCUIT

(75) Inventors: Atsushi OSHIMA, Shiojiri-shi (JP); Kunio TABATA, Shiojiri-shi (JP); Shinichi MIYAZAKI, Suwa-shi (JP); Hiroyuki YOSHINO, Matsumoto-shi (JP); Noritaka IDE, Shiojiri-shi (JP)

(73) Assignee: SEIKO EPSON CORPORATION, Tokyo (JP)

(21) Appl. No.: 12/944,060

(22) Filed: Nov. 11, 2010

(30) Foreign Application Priority Data
Nov. 27, 2009 (JP) 2009-269669

(51) Int. Cl. B41J 29/38; H02J 4/00

(52) U.S. Cl. 347/10; 307/39

(57) ABSTRACT

A capacitive load driving circuit includes: a voltage waveform output unit that outputs a voltage waveform used for driving a plurality of capacitive loads; and a voltage waveform applying unit that connects each of the plurality of capacitive loads to output of the voltage waveform output unit to thereby apply the voltage waveform to each of the plurality of capacitive loads, wherein the voltage waveform applying unit releases the connection between the capacitive load and the output of the voltage waveform output unit when voltage of the voltage waveform falls outside a voltage range determined for each of the plurality of capacitive loads, and connects the capacitive load to the output of the voltage waveform output unit when the voltage of the voltage waveform falls within the voltage range, to thereby apply a different voltage waveform to each of the plurality of capacitive loads.

### BACKGROUND

1. Technical Field

The present invention relates to a technique for applying a voltage to drive a capacitive load.

2. Related Art

A technique for applying a voltage to drive a load of an electronic element such as a semiconductor element or a dielectric element has been widely used in various devices. In a fluid ejection device such as an inkjet printer for example, a voltage is applied to a piezo element that expands and contracts according to the voltage, so that fluid is pushed out of an ejection nozzle and ejected. In a display device such as a liquid crystal display or an organic EL display, a voltage is applied to liquid crystal to align liquid crystal molecules, or a voltage is applied to an organic EL element to cause it to emit light, so that an image is displayed. A technique for applying a voltage to various loads such as a motor or an electromagnet, in addition to the electronic element, to drive the load has also been widely used.

In such a technique for driving the load, a voltage to be applied to the load is formed to be a predetermined waveform, and then the waveform is applied to the load. By controlling the waveform of voltage (voltage waveform) to be applied to the load, operation of the load is controlled. In some cases, a plurality of loads are driven. In an inkjet printer for example, a plurality of ejection nozzles are driven to eject a plurality of ink drops, thereby making it possible to print an image at high speed. When the plurality of loads are driven in this manner, a technique is used in which the plurality of loads to be driven are connected in parallel, and a voltage waveform generated by one voltage waveform generating circuit is applied to each of the loads, whereby the plurality of loads can be driven (for example, JP-A-2008-260225).

However, when a voltage waveform generated by one voltage waveform generating circuit is applied to the plurality of loads, there is a problem in that the operation of the loads varies because the characteristics of the individual loads are not perfectly uniform. In an inkjet printer for example, since it is difficult to achieve the perfect uniformity in the port diameter or channel resistance of an ejection nozzle across a plurality of ejection nozzles, the size of an ink drop to be ejected or the speed thereof varies from ejection nozzle to ejection nozzle even when the same voltage waveform is applied. Since it is generally difficult to achieve the perfect uniformity in the characteristics of the plurality of loads, such variations in the operation of the loads may generally occur not only in an inkjet printer but also in devices in which a voltage waveform generated by one voltage waveform generating circuit is applied to a plurality of loads. It is of course possible to suppress variations in operation if a voltage waveform considering the characteristic of each of the loads is generated for each of them. However, this needs a large number of voltage waveform generating circuits, failing to keep the circuit scale simple.

### SUMMARY

An advantage of some aspects of the invention is to provide a technique that can uniformly operate a plurality of loads by suppressing variations in the operation of the loads while keeping a circuit scale simple by applying one voltage waveform to the plurality of loads.

A capacitive load driving circuit according to an aspect of the invention employs the following configuration. That is, the capacitive load driving circuit according to the aspect of the invention includes: a voltage waveform output unit that outputs a voltage waveform used for driving a plurality of capacitive loads; and a voltage waveform applying unit that connects each of the plurality of capacitive loads to output of the voltage waveform output unit to thereby apply the voltage waveform to each of the plurality of capacitive loads, wherein the voltage waveform applying unit releases the connection between the capacitive load and the output of the voltage waveform output unit when voltage of the voltage waveform falls outside a voltage range determined for each of the plurality of capacitive loads, and connects the capacitive load to the output of the voltage waveform output unit when the voltage of the voltage waveform falls within the voltage range, to thereby apply a different voltage waveform to each of the plurality of capacitive loads.

In the capacitive load driving circuit according to the aspect of the invention, the output of the voltage waveform output unit is connected to the plurality of capacitive loads, whereby each of the capacitive loads is driven. In this case, when the voltage of the voltage waveform output from the voltage waveform output unit exceeds the voltage range determined for each of the capacitive loads, the connection between the capacitive load and the voltage waveform output unit is released, and when the voltage of the voltage waveform returns to within the voltage range, the connection that has been released is made again, whereby a different voltage waveform is applied to each of the capacitive loads.

The capacitive load can store electric charge therein with the application of voltage, thereby holding the voltage. Therefore, when the connection between the capacitive load and the voltage waveform output unit is released, the capacitive load holds the voltage having been applied thereto as it is upon releasing the connection. By connecting the capacitive load again to the output of the voltage waveform output unit after the voltage of the voltage waveform returns to the voltage range, a voltage waveform output by the voltage waveform output unit can be applied to the capacitive load after that. As a result, it is possible to apply a voltage waveform different from the voltage waveform output by the voltage waveform output unit to each of the capacitive loads. By doing this, even when a voltage waveform output by one voltage waveform output unit is applied to a plurality of capacitive loads, a different voltage waveform can be applied to each of the capacitive loads. Therefore, by previously determining the voltage range of each of the capacitive loads according to the characteristic of each of the capacitive loads, a proper voltage waveform according to the characteristic of each of the capacitive loads can be applied. As a result, even when output of one voltage waveform output unit is applied to a plurality of capacitive loads, variations in operation among the capacitive loads can be suppressed by applying a proper voltage waveform according to the characteristic of each of the capacitive loads and properly operating each of the capacitive loads.

For releasing the connection between the capacitive load and the voltage waveform output unit, any method may be used as long as the connection of the capacitive load is released upon exceeding the voltage range determined for the capacitive load. For example, by measuring the voltage of the voltage waveform output by the voltage waveform output unit, the connection may be released upon detection of measured voltage exceeding the voltage range. Alternatively, by previously acquiring a timing in which the voltage of the voltage waveform exceeds the voltage range, the connection may be released upon reaching the timing. Similarly, for connecting the capacitive load with the voltage waveform output unit, any method may be used as long as the capacitive load is connected upon return of the voltage of the voltage waveform to the voltage range. For example, by measuring the voltage of the voltage waveform, the connection may be made upon detection of measured voltage returning to the voltage range. Alternatively, by previously acquiring a timing in which the voltage of the voltage waveform returns to the voltage range, the connection may be made upon reaching the timing.

In the capacitive load driving circuit according to the aspect of the invention, for connecting again the capacitive load whose connection with the output of the voltage waveform output unit has been released to the output of the voltage waveform output unit, the connection may be made as follows. That is, when the voltage of the voltage waveform increases after releasing the connection, the voltage waveform output unit and the capacitive load are connected via a rectifying element in a state where the rectifying element is connected in a direction in which current is blocked from flowing into the capacitive load. In contrast, when the voltage of the voltage waveform decreases after releasing the connection of the capacitive load, the voltage waveform output unit and the capacitive load are connected via the rectifying element in a state where the rectifying element is connected in a direction in which current is blocked from flowing out of the capacitive load.

When the voltage of the voltage waveform increases after releasing the connection of the capacitive load, the voltage of the voltage waveform becomes higher than that held by the capacitive load. Therefore, by connecting the capacitive load with the output of the voltage waveform output unit via the rectifying element disposed in the direction in which current is blocked from flowing into the capacitive load, a change in the voltage of the capacitive load can be blocked until the voltage of the voltage waveform output by the voltage waveform output unit decreases to the voltage of the capacitive load because the current flowing from the voltage waveform output unit to the capacitive load is blocked. When the voltage of the voltage waveform decreases to the voltage of the capacitive load, current starts flowing between the capacitive load and the output of the voltage waveform output unit. Therefore, the capacitive load can be connected to the output of the voltage waveform output unit at a timing in which the voltage of the voltage waveform and the voltage of the capacitive load coincide with each other. Thus, when the voltage of the capacitive load is changed by connecting the capacitive load to the output of the voltage waveform output unit, the voltage of the capacitive load can be smoothly changed. Therefore, a more proper voltage waveform can be applied to the capacitive load.

Similarly, when the voltage of the voltage waveform decreases after releasing the connection of the capacitive load, by connecting the rectifying element in the direction in which current is blocked from flowing out of the capacitive load, a change in the voltage of the capacitive load can be blocked by blocking current flowing from the capacitive load to the voltage waveform output unit until the decreased voltage of the voltage waveform increases to the voltage of the capacitive load. When the voltage of the voltage waveform increases to the voltage of the capacitive load, the output of the voltage waveform output unit and the capacitive load can be connected at the timing in which the voltage of the voltage waveform and the voltage of the capacitive load coincide with each other. Therefore, a proper voltage waveform whose voltage changes smoothly can be applied to the capacitive load.

The rectifying element is not limited to a diode. Any element may be used as long as it allows forward current to flow but blocks reverse current. For example, the portion between the base terminal and emitter terminal of a transistor may be used as a rectifying element. Also in this case, since the capacitive load can be connected to the output of the voltage waveform output unit at a proper timing by controlling current, an accurate voltage waveform can be applied to the capacitive load.

The capacitive load driving circuit according to the aspect of the invention can be recognized as the following aspect. That is, a capacitive load driving circuit according to this aspect of the invention includes: a voltage waveform output unit that outputs a voltage waveform used for driving a first capacitive load and a second capacitive load; and a voltage waveform applying unit that applies the voltage waveform to the first capacitive load and the second capacitive load, wherein the voltage waveform applying unit releases the connection between the first capacitive load and output of the voltage waveform output unit when voltage of the voltage waveform falls outside a first voltage range determined for the first capacitive load, and connects the first capacitive load to the output of the voltage waveform output unit when the voltage of the voltage waveform falls within the first voltage range, while releasing the connection between the second capacitive load and the output of the voltage waveform output unit when the voltage of the voltage waveform falls outside a second voltage range determined for the second capacitive load and at least a part of which is different from the first voltage range, and connecting the second capacitive load to the output of the voltage waveform output unit when the voltage of the voltage waveform falls within the second voltage range, to thereby apply a different voltage waveform to each of the first capacitive load and the second capacitive load.

A method for driving capacitive loads according to another aspect of the invention, which corresponds to the capacitive load driving circuit according to the above aspect of the invention, can be recognized as follows. That is, the method for driving capacitive loads includes: outputting a voltage waveform used for driving a first capacitive load and a second capacitive load; and applying the voltage waveform to the first capacitive load and the second capacitive load, wherein in applying the voltage waveform, the connection between the first capacitive load and output of the voltage waveform output unit is released when voltage of the voltage waveform falls outside a first voltage range determined for the first capacitive load, and the first capacitive load is connected to the output of the voltage waveform output unit when the voltage of the voltage waveform falls within the first voltage range, while the connection between the second capacitive load and the output of the voltage waveform output unit is released when the voltage of the voltage waveform falls outside a second voltage range determined for the second capacitive load and at least a part of which is different from the first voltage range, and the second capacitive load is connected to the output of the voltage waveform output unit when the voltage of the voltage waveform falls within the second voltage range, whereby a different voltage waveform is applied to each of the first capacitive load and the second capacitive load.

In the capacitive load driving circuit and the method for driving capacitive loads according to these aspects of the invention, each of the capacitive loads is driven by connecting the output of the voltage waveform output unit to the first capacitive load and the second capacitive load. When the voltage of the voltage waveform output from the voltage waveform output unit exceeds the voltage range (first voltage range and second voltage range) determined for each of the capacitive loads, the connection between the capacitive load and the voltage waveform output unit is released, and when the voltage of the voltage waveform returns to within the voltage range, the connection that has been released is made again, whereby voltage waveforms different from each other are respectively applied to the first capacitive load and the second capacitive load.

Since the first capacitive load and the second capacitive load are each a capacitive element, when the connection with the output of the voltage waveform output unit is released, each of the capacitive loads holds the voltage having been applied thereto upon releasing the connection. After the voltage of the voltage waveform returns to within the voltage range, and the capacitive load is connected again to the output of the voltage waveform output unit, the voltage waveform output by the voltage waveform output unit is applied. As a result, a voltage waveform different from the voltage waveform output by the voltage waveform output unit can be applied to each of the capacitive loads. Since the voltage waveform to be applied to each of the capacitive loads is determined by the voltage range determined for each of the capacitive loads, voltage waveforms different from each other can be respectively applied to the first capacitive load and the second capacitive load by previously setting the first voltage range and the second voltage range to be different from each other. As a result, even when output of one voltage waveform output unit is applied to the first capacitive load and the second capacitive load, variations in operation among the capacitive loads can be suppressed by applying a proper voltage waveform conforming to the characteristic of each of the capacitive loads.

Since using the capacitive load driving circuit according to the above aspect of the invention makes it possible to drive an actuator disposed in an ejection nozzle to properly eject fluid through the ejection nozzle, the invention can be recognized as a fluid ejection device including the load driving circuit, which is still another aspect according to the invention.

In the fluid ejection device according to this aspect of the invention, variations in operation among actuators can be suppressed due to the load driving circuit. As a result, variations in the amount of fluid or size of fluid drop to be ejected, in the ejecting speed of fluid or the like can be reduced to properly eject fluid.

Since the fluid ejection device according to this aspect of the invention can be mounted on a printer, the invention can be recognized as a printer on which the fluid ejection device is mounted, which is yet another aspect according to the invention.

In the printer according to this aspect of the invention, by suppressing variations in operation among actuators due to the capacitive load driving circuit, variations in the amount of fluid such as ink or the size of fluid drop can be suppressed to properly eject a fluid drop. Therefore, a high-quality image can be printed.

### BRIEF DESCRIPTION OF THE DRAWINGS

The invention will be described with reference to the accompanying drawings, wherein like numbers reference like elements.

FIG. 1 is an explanatory diagram schematically showing the configuration of an inkjet printer on which a piezo element driving circuit of an embodiment is mounted.

FIG. 2 is an explanatory diagram showing the internal mechanism of an ejection head in detail.

FIG. 3 is an explanatory diagram illustrating a voltage waveform (drive voltage waveform) to be applied to a piezo element.

FIG. 4 is an explanatory diagram showing the configuration of the piezo element driving circuit and its peripheral circuit included in the inkjet printer of the embodiment.

FIGS. 5A to 5C are explanatory diagrams conceptually showing a state of applying a drive voltage waveform generated by a drive voltage waveform generating circuit to a piezo element in the inkjet printer of the embodiment.

FIGS. 6A and 6B are explanatory diagrams showing a gate unit of a first modified example where a path in which current directed from the drive voltage waveform generating circuit toward the piezo element flows and a path in which current directed from the piezo element toward the drive voltage waveform generating circuit flows are separately disposed.

FIGS. 7A to 7C are explanatory diagrams showing a state of applying a drive voltage waveform to the piezo element using the gate unit of the first modified example.

FIGS. 8A to 8C are explanatory diagrams showing a state of applying a drive voltage waveform to the piezo element using the gate unit of the first modified example.

FIGS. 9A to 9C are explanatory diagrams showing a state of applying a voltage waveform to the piezo element using a gate unit of a third modified example where two gate elements are exclusively manipulated.

FIGS. 10A and 10B are explanatory diagrams showing a gate unit of a fourth modified example where the gate element is manipulated according to data describing the output voltage of a drive voltage waveform when operating the gate element.

FIGS. 11A and 11B are explanatory diagrams illustrating a state of manipulating, according to gate timing data, the gate element of an ejection port through which an ink drop is not to be ejected.

### DESCRIPTION OF EXEMPLARY EMBODIMENTS

Hereinafter, an embodiment of the invention will be described according to the following order for clarifying the contents of the invention.

### A. Device Configuration of Inkjet Printer

### B. Method for Applying Drive Voltage Waveform of Embodiment

### C. Modified Examples

C-1. First Modified Example

C-2. Second Modified Example

C-3. Third Modified Example

C-4. Fourth Modified Example

C-5. Fifth Modified Example

### A. Device Configuration of Inkjet Printer

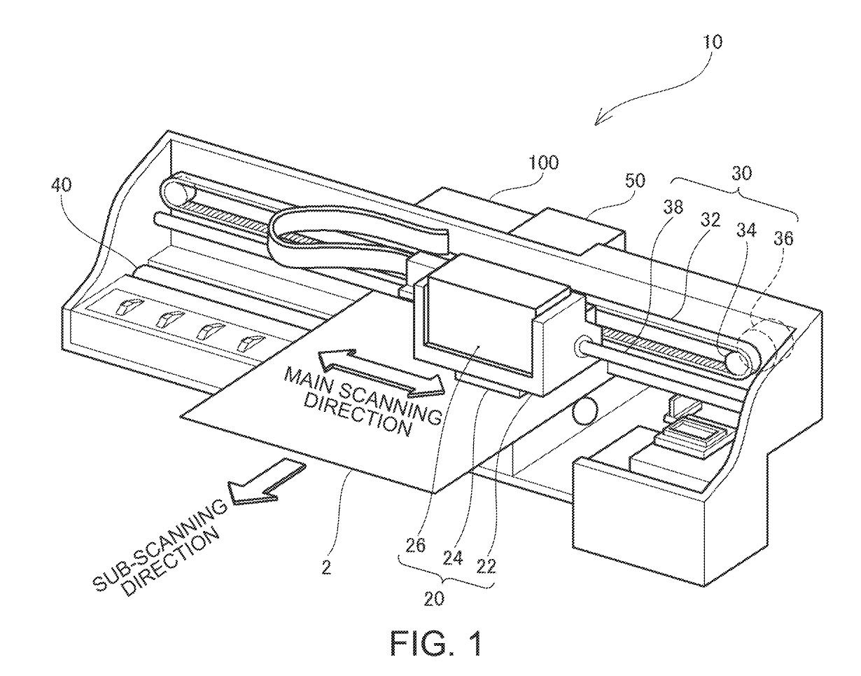

FIG. 1 is an explanatory diagram schematically showing the configuration of an inkjet printer (corresponding to the “printer”) on which a piezo element driving circuit (corresponding to the “capacitive load driving circuit”) of the embodiment is mounted. As shown in the drawing, the inkjet printer 10 includes a carriage 20 that reciprocates in a main scanning direction to form an ink dot on a print medium 2, a drive mechanism 30 that makes the carriage 20 reciprocate, and a platen roller 40 that feeds the print medium 2. The carriage 20 is provided with an ink cartridge 26 accommodating ink therein, a carriage case 22 into which the ink cartridge 26 is loaded, an ejection head 24 (corresponding to the “fluid ejection device”) that is mounted on the bottom side (side facing the print medium 2) of the carriage case 22 to eject ink, and the like. The ink in the ink cartridge 26 can be guided to the ejection head 24 to eject a correct amount of ink from the ejection head 24 to the print medium 2.

The drive mechanism 30 that makes the carriage 20 reciprocate includes a guide rail 38 extending in the main scanning direction, a timing belt 32 having a plurality of teeth formed inside thereof, and a drive pulley 34 and a step motor 36 for driving the timing belt 32. A part of the timing belt 32 is fixed to the carriage case 22. By driving the timing belt 32, the carriage case 22 can be moved along the guide rail 38 with good accuracy.

The platen roller 40 is driven using a not-shown drive motor or gear mechanism, so that it can feed the print medium 2 in a sub-scanning direction by a predetermined amount. These mechanisms are controlled by a printer control circuit 50 mounted on the inkjet printer 10. Under the control of the printer control circuit 50, the platen roller 40 feeds the print medium 2, and the carriage case 22 causes the ejection head 24 to eject ink while moving in the main scanning direction, whereby an image is printed on the print medium 2.

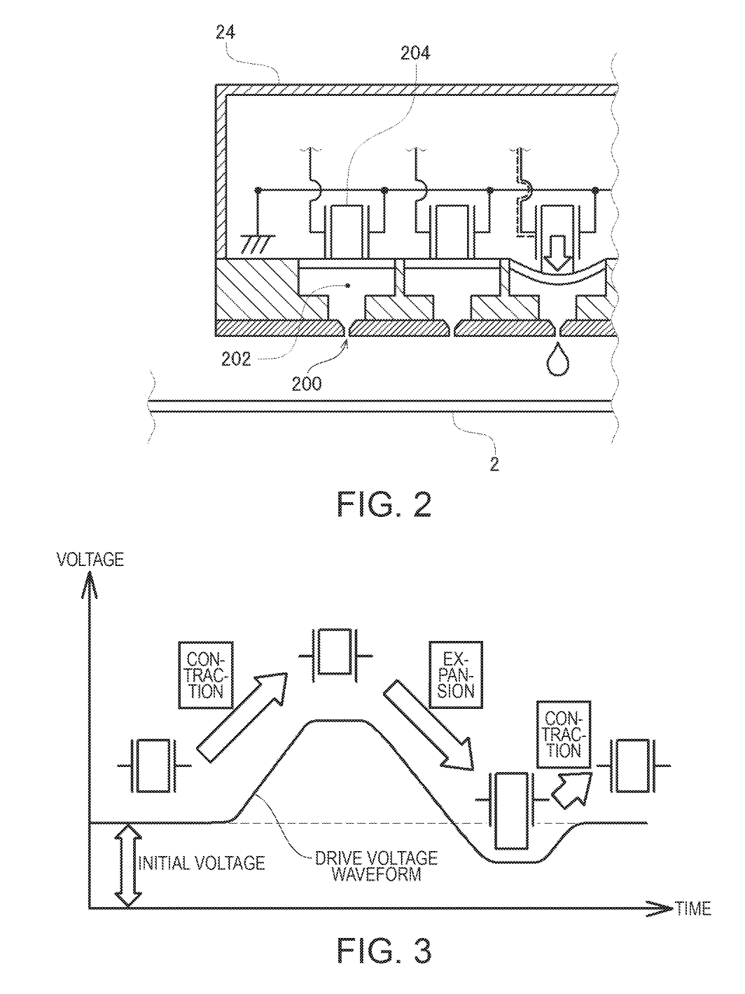

FIG. 2 is an explanatory diagram showing the internal mechanism of the ejection head in detail. As shown in the drawing, a bottom surface (surface facing the print medium 2) of the ejection head 24 is provided with a plurality of ejection ports 200. Ink drops can be ejected through each of the ejection ports 200. The ejection port 200 is connected to each of ink chambers 202. The ink chamber 202 is filled with ink supplied from the ink cartridge 26. A piezo element 204 (corresponding to the “capacitive load”) is disposed on the ink chamber 202. When a voltage is applied to the piezo element 204, the piezo element 204 is deformed to pressurize the ink chamber 202, so that an ink drop can be ejected through the ejection port 200. Since the deformation amount of the piezo element 204 varies depending on the voltage value of the applied voltage, the size of the ink drop to be ejected can be controlled by adjusting the force or timing to press the ink chamber 202 by properly controlling the voltage to be applied to the piezo element 204. Therefore, the inkjet printer 10 applies the following voltage waveform to the piezo element 204.

FIG. 3 is an explanatory diagram illustrating a voltage waveform (drive voltage waveform) to be applied to the piezo element. As shown in the drawing, the drive voltage waveform has a trapezoidal shape in which the voltage increases with a lapse of time, and then decreases to its original voltage value. FIG. 3 shows the piezo element 204 that expands and contracts according to the drive voltage waveform. As shown in the drawing, as the voltage value of the drive voltage waveform is increased, the piezo element 204 is gradually contracted. In this case, since the ink chamber 202 is pulled by the piezo element 204 and thus expanded, the ink can be supplied from the ink cartridge 26 into the ink chamber 202. When the voltage value is increased to reach its peak and thereafter is decreased, the piezo element 204 is expanded this time to compress the ink chamber 202, so that ink is ejected through the ejection port 200. In this case, the drive voltage waveform drops to a voltage value lower than the original voltage value (voltage value shown as “initial voltage” in the drawing), so that the piezo element 204 can be expanded more than the initial state to sufficiently push the ink out. Thereafter, the drive voltage waveform returns to the initial voltage, and the piezo element 204 also returns to the initial state correspondingly.

In this manner, the inkjet printer 10 is provided with the piezo element 204 in the ink chamber 202, and can apply a proper drive voltage waveform to the piezo element 204 to thereby eject ink drops from the ejection head 24. Therefore, the inkjet printer 10 includes a piezo element driving circuit 100 that generates a drive voltage waveform and applies the same to the piezo element 204, in addition to the printer control circuit 50 that controls the operations of the respective mechanism.

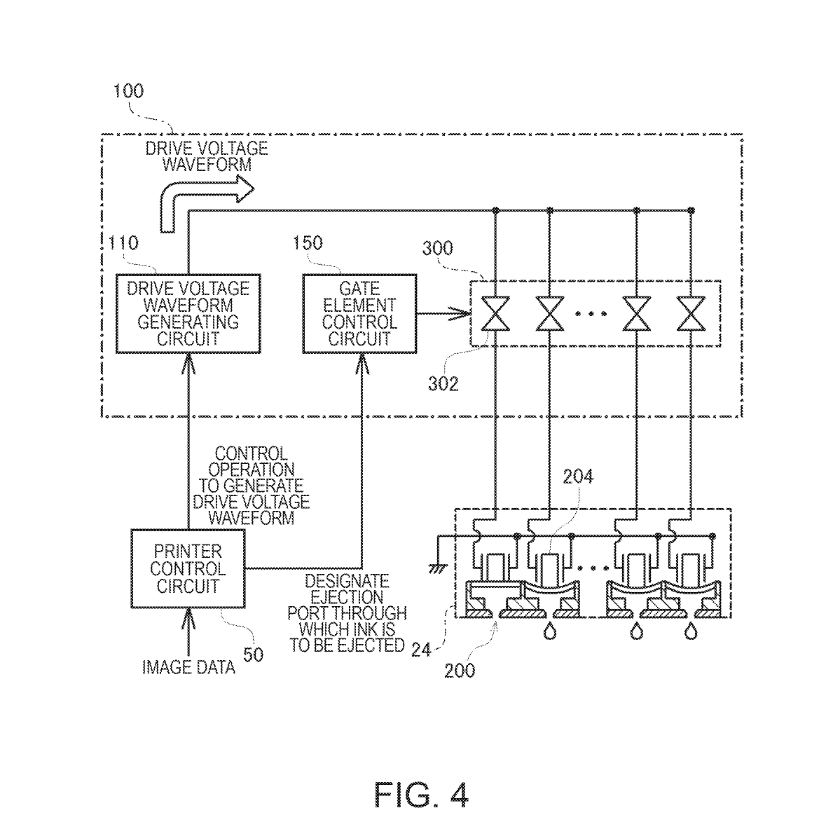

FIG. 4 is an explanatory diagram showing the configuration of the piezo element driving circuit and its peripheral circuit included in the inkjet printer of the embodiment. As shown in the drawing, the piezo element driving circuit 100 includes a drive voltage waveform generating circuit 110 (corresponding to the “voltage waveform output unit”) that generates a drive voltage waveform, and a gate unit 300 (corresponding to the “voltage waveform applying unit”) that guides the drive voltage waveform generated by the drive voltage waveform generating circuit 110 to the piezo element 204. The drive voltage waveform generating circuit 110 includes a power source that generates a voltage, and a waveform generating circuit that changes the voltage from the power source to generate a voltage waveform. The drive voltage waveform generating circuit 110 can generate a predetermined drive voltage waveform according to the instructions of the printer control circuit 50.

The drive voltage waveform generated by the drive voltage waveform generating circuit 110 is output to the gate unit 300 as shown in the drawing. The gate unit 300 is composed of a plurality of gate elements 302 connected in parallel. The piezo element 204 is connected to each of the gate elements 302. The gate elements 302 can be individually brought into a conductive state or a disconnection state. By bringing only the gate element 302 of an ejection port through which ink is desired to be ejected into the conductive state, a drive voltage waveform can be applied only to the corresponding piezo element 204, so that an ink drop can be ejected through the ejection port 200. The gate elements 302 are manipulated by a gate element control circuit 150. The gate element control circuit 150 manipulates each of the gate elements 302 according to a command from the printer control circuit 50.

The printer control circuit 50 uses the circuit configuration described above to print an image as follows. First, based on image data desired to be printed, the printer control circuit 50 determines the ejection port 200 through which an ink drop is to be ejected and the waveform of a drive voltage waveform for ejecting an ink drop. The printer control circuit 50 sends a command to the gate element control circuit 150 to bring the gate element 302 of the ejection port 200 through which an ink drop is to be ejected into the conductive state, and operates the drive voltage waveform generating circuit 110 to generate the drive voltage waveform. The generated drive voltage waveform is applied to the piezo element 204 of the target ejection port 200 via the gate element 302. As a result, an ink drop is ejected through the target ejection port 200.

In the inkjet printer of the embodiment in this case as shown in the drawing, the gate elements 302 are connected to the drive voltage waveform generating circuit 110 in a state of being connected in parallel. Therefore, by bringing the plurality of gate elements 302 into the conductive state, a drive voltage waveform can be applied to the plurality of the piezo elements 204. By doing this, since ink drops can be ejected through the plurality of ejection ports 200 by generating only one drive voltage waveform, an image can be printed at high speed.

However, when one drive voltage waveform is applied to the plurality of the piezo elements 204 as described above, the size or speed of the ink drop to be ejected varies from the ejection port 200 to the ejection port 200 in some cases because of variations in the port diameter of the ejection ports 200 or variations in the operating characteristic of the piezo elements 204. If the size or speed of the ink drop to be ejected varies from the ejection port 200 to the ejection port 200, it is difficult to improve the quality of a printed image because the ink drop cannot be ejected with a uniform size, for example. The variations can be of course reduced by generating and applying drive voltage waveforms conforming to the characteristics of the individual ejection ports 200 by, for example, applying a drive voltage waveform whose amplitude is slightly reduced for the ejection port 200 whose ink drop to be ejected is large in size. However, generating a drive voltage waveform for each of the individual ejection ports 200 requires a large number of drive voltage waveform generating circuits 110, resulting in an increase in the size of the device configuration. In the inkjet printer 10 of the embodiment, therefore, a drive voltage waveform generated by one drive voltage waveform generating circuit 110 is applied to the piezo element 204 as follows, whereby a different drive voltage waveform can be applied to each of the piezo elements 204 of the individual ejection ports 200 without increasing the number of drive voltage waveform generating circuits 110.

### B. Method for Applying Drive Voltage Waveform of Embodiment

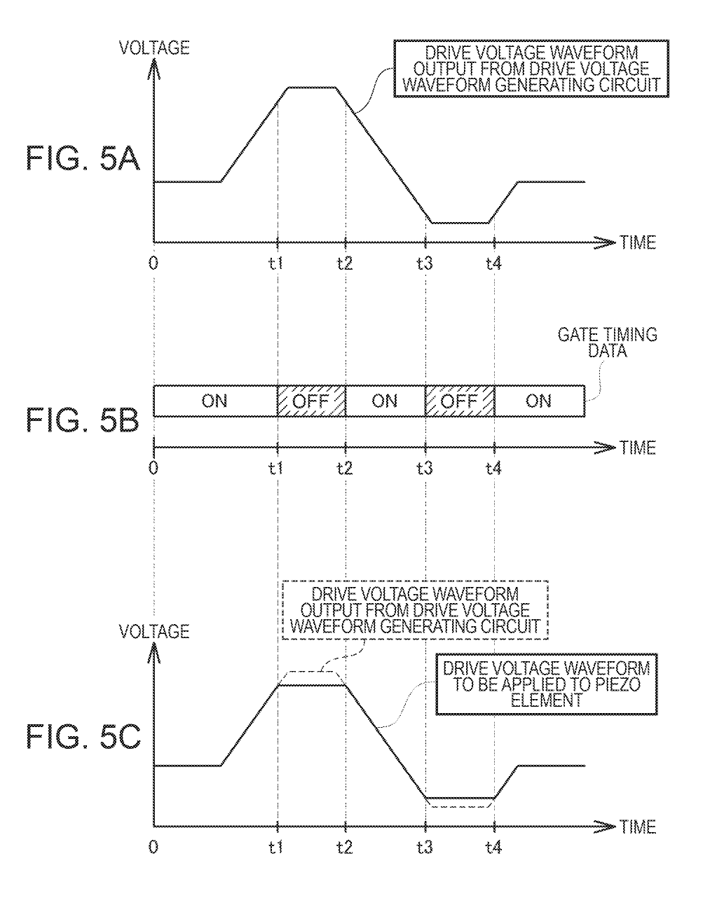

FIGS. 5A to 5C are explanatory diagrams conceptually showing a state of applying a drive voltage waveform generated by the drive voltage waveform generating circuit to the piezo element in the inkjet printer of the embodiment. FIG. 5A illustrates the drive voltage waveform generated by the drive voltage waveform generating circuit 110. In the inkjet printer 10 of the embodiment as described above, such a drive voltage waveform is sent to the gate element 302 connected to each of the piezo elements 204 (refer to FIG. 4). Therefore, the gate element control circuit 150 can apply the drive voltage waveform to the piezo element 204 of the target ejection port 200 by bringing the gate element 302 of the target ejection port 200 into the conductive state.

However, when the gate element 302 is simply brought into the conductive state, the drive voltage waveform generated by the drive voltage waveform generating circuit 110 is applied as it is to the piezo element 204. Therefore, a drive voltage waveform conforming to the characteristic of each of the individual ejection ports 200 or piezo elements 204 cannot be applied. In the inkjet printer 10 of the embodiment, therefore, after the printer control circuit 50 designates the ejection port 200 through which an ink drop is to be ejected, the gate element control circuit 150 does not simply bring the gate element 302 of the ejection port 200 into the conductive state, but manipulates the gate element 302 according to gate timing data described below.

FIG. 5B is an explanatory diagram illustrating the gate timing data used for manipulating the gate element 302. As shown in the drawing, the gate timing data is data describing timings at which the gate element 302 is brought into the conductive state (state shown as “ON” in FIG. 5B) or the disconnection state (state shown as “OFF” in FIG. 5B) along the time axis (horizontal direction in FIG. 5B). In the inkjet printer 10 of the embodiment, such gate timing data is previously stored on a ROM in the gate element control circuit 150 for each of the gate elements 302, and when the printer control circuit 50 determines the ejection port 200 through which an ink drop is to be ejected, the gate element control circuit 150 can read out and acquire from the ROM the gate timing data of the gate element 302 corresponding to the ejection port 200.

As shown in FIG. 5B in this case, in the gate timing data, not only the timing of bringing the gate element 302 into the conductive state (“ON” state) but also the timing of bringing the gate element 302 into the disconnection state (“OFF” state) are designated. Therefore, when the gate element 302 is manipulated according to the gate timing data, the piezo element 204 and the drive voltage waveform generating circuit 110 are not always in a state of being connected to each other, but the piezo element 204 and the drive voltage waveform generating circuit 110 are in a state of being disconnected from each other in a specified period of time (in the example of FIG. 5B, the period from a timing shown as “t1” to a timing shown as “t2” and the period from a timing shown as “t3” to a timing shown as “t4”). However, while the piezo element 204 and the drive voltage waveform generating circuit 110 are disconnected from each other, the drive voltage waveform generating circuit 110 does not stop outputting a drive voltage waveform but continues to output a drive voltage waveform. In this manner, even though the drive voltage waveform generating circuit 110 continues to output a drive voltage waveform, the drive voltage waveform generating circuit 110 and the piezo element 204 are disconnected, whereby a voltage waveform different from the drive voltage waveform output by the drive voltage waveform generating circuit 110 can be applied to the piezo element 204 in the inkjet printer 10 of the embodiment as will be described below.

FIG. 5C shows a state where the gate element control circuit 150 manipulates the gate element 302 according to the gate timing data shown in FIG. 5B to thereby apply a drive voltage waveform to the piezo element 204. In the gate timing data illustrated in FIG. 5B, since it is first instructed to bring the gate element 302 into the conductive state (“ON” state) (refer to a timing shown as “0” on the horizontal axis of FIG. 5B), the gate element control circuit 150 brings the gate element 302 into the conductive state (“ON” state) according to this instruction. Thus, a drive voltage waveform output by the drive voltage waveform generating circuit 110 is applied to the piezo element 204, and the voltage of the piezo element 204 increases (refer to the period from the timing shown as “0” to the timing shown as “t1” in FIG. 5C).

Next, when the timing shown as “t1” in FIG. 5B is reached, since the gate timing data instructs the gate element control circuit 150 to bring the gate element 302 into the OFF state (disconnection state), the gate element control circuit 150 brings the gate element 302 into the OFF state according to this instruction. Thus, the piezo element 204 is disconnected from the drive voltage waveform generating circuit 110, and the drive voltage waveform is not applied to the piezo element 204. In this case, since the piezo element 204 is a capacitive load that can store the applied voltage therein, the piezo element 204 does not lose its voltage completely but can hold the voltage having been applied thereto until just before the disconnection even without the application of the drive voltage waveform. Consequently, when the gate element 302 is bought into the disconnection state as shown in the period from the timing shown as “t1” to the timing shown as “t2” in FIG. 5C, the piezo element 204 holds the voltage (voltage at the timing shown as “t1” in FIG. 5C) having been applied thereto just before the disconnection as it is. As a result, a voltage different from the voltage (refer to the voltage shown by broken lines in FIG. 5C) of the drive voltage waveform is applied to the piezo element 204 (refer to the voltage shown by solid lines in FIG. 5C).

When the timing shown as “t2” in FIG. 5B is reached after a further lapse of time, the gate element control circuit 150 brings the gate element 302 into the conductive state again according to an instruction of the gate timing data, to thereby connect the drive voltage waveform generating circuit 110 with the piezo element 204. When the piezo element 204 and the drive voltage waveform generating circuit 110 are connected, the voltage of the drive voltage waveform output by the drive voltage waveform generating circuit 110 is applied as it is to the piezo element 204. Therefore, the drive voltage waveform can be applied to the piezo element 204 while decreasing the voltage of the piezo element 204 according to a decrease in the voltage of the drive voltage waveform (refer to the period from the timing shown as “t2” to the timing shown as “t3” in FIG. 5C).

In connecting the drive voltage waveform generating circuit 110 with the piezo element 204, it is preferable to connect the piezo element 204 with the drive voltage waveform generating circuit 110 in a state where the difference between the voltage of the piezo element 204 and the voltage of the drive voltage waveform generating circuit 110 is small for preventing a rapid change in the voltage of the piezo element 204. As described above in this case, since the piezo element 204 is a capacitive load, it is considered that the piezo element 204 holds the voltage (voltage at the timing shown as “t1” in FIG. 5C) upon disconnection as it is even after disconnected from the drive voltage waveform generating circuit 110. Therefore, if the drive voltage waveform generating circuit 110 and the piezo element 204 are connected again at a timing in which the output voltage (voltage of the drive voltage waveform) of the drive voltage waveform generating circuit 110 drops to the voltage (voltage at the timing shown as “t1” in FIG. 5C) of the drive voltage waveform when the piezo element 204 and the drive voltage waveform generating circuit are disconnected, the piezo element 204 and the drive voltage waveform generating circuit 110 can be connected in a state where the voltages of them are substantially equal to each other. Because of this reason, in setting the gate timing data, it is preferable to set the gate timing data so that the voltage (voltage at the timing shown as “t1” in FIG. 5C) of the drive voltage waveform when the gate element 302 is brought into the disconnection state and the voltage (voltage of the drive voltage waveform at the timing shown as “t2” in FIG. 5C) of the drive voltage waveform when the gate element 302 is brought into the conductive state coincide with each other.

When the timing shown as “t3” in FIG. 5B is reached after the gate element 302 is brought into the conductive state, since the gate timing data instructs this time the gate element control circuit 150 to bring the gate element 302 into the OFF state (disconnection state) again, the gate element control circuit 150 brings the gate element 302 into the disconnection state according to this instruction. Thus, the drive voltage waveform output by the drive voltage waveform generating circuit 110 is not applied to the piezo element 204. As described above in this case, since the piezo element 204 is a capacitive load, the voltage having been applied thereto until just before the disconnection continues to be applied as it is to the piezo element 204 when the piezo element 204 is disconnected from the drive voltage waveform generating circuit 110. As a result as shown in FIG. 5C, a voltage higher than the voltage (refer to the voltage shown by broken lines in FIG. 5C) of the drive voltage waveform continues to be applied to the piezo element 204 (refer to the period from the timing shown as “t3” to the timing shown as “t4” in FIG. 5C).

Thereafter, when the timing shown as “t4” in the drawing is reached, the gate element control circuit 150 brings the gate element 302 into the “ON” state (conductive state) again according to the gate timing data. Also in this case as described above, the gate element 302 is brought into the conductive state at the timing in which the voltage of the drive voltage waveform and the voltage of the piezo element 204 are substantially the same, whereby a change in the voltage of the piezo element 204 can be minimized when the piezo element 204 and the drive voltage waveform generating circuit 110 are connected. After connecting the drive voltage waveform generating circuit 110 with the piezo element 204 in this manner, since the drive voltage waveform generated by the drive voltage waveform generating circuit 110 is applied as it is to the piezo element 204, the voltage of the piezo element 204 increases according to the drive voltage waveform. By manipulating the gate element 302 according to the gate timing data in FIG. 5B as described above, the voltage waveform shown by the solid lines in FIG. 5C is applied to the piezo element 204.

In the piezo element driving circuit 100 of the embodiment in this manner, while the drive voltage waveform generating circuit 110 outputs a drive voltage waveform, the piezo element 204 and the drive voltage waveform generating circuit 110 are not always connected but are disconnected in parts of the period. By doing this, the entire drive voltage waveform output from the drive voltage waveform generating circuit 110 is not applied to the piezo element 204, but only the parts thereof can be applied. Therefore, a voltage waveform different from the drive voltage waveform output by the drive voltage waveform generating circuit 110 can be applied to the piezo element 204. In the embodiment, the piezo element 204 and the drive voltage waveform generating circuit 110 are disconnected while the voltage of the drive voltage waveform exceeds a certain voltage value and falls below a certain voltage value. By doing this, since only a part of the amplitude of the drive voltage waveform can be applied to the piezo element 204, a voltage waveform (waveform shown by the solid lines in FIG. 5C) different in amplitude from the drive voltage waveform (waveform shown by the broken lines in FIG. 5C) output by the drive voltage waveform generating circuit 110 can be applied to the piezo element 204 as shown in FIG. 5C.

In applying the drive voltage waveform output from the drive voltage waveform generating circuit 110 to the plurality of piezo elements 204, gate timing data corresponding to each of the piezo elements 204 is read out, and the gate element 302 corresponding to each of the piezo elements 204 is manipulated according to each piece of the gate timing data, whereby voltage waveforms different in amplitude from one another can be respectively applied to the piezo elements 204. By previously setting gate timing data of each of the ejection ports 200 according to the characteristic of each of the ejection ports 200, variations among the plurality of ejection ports 200 can be suppressed because a drive voltage waveform having a proper amplitude according to the characteristic of each of the ejection ports 200 can be applied. For example, for the ejection port 200 through which an ink drop having a larger size than the other ejection ports 200 is ejected when the same voltage waveform is applied, the timing in which the drive voltage waveform generating circuit 110 and the piezo element 204 are disconnected (the timing shown as “t1” and the timing shown as “t3” in FIG. 5B) is set earlier in gate timing data so that the amplitude of the voltage waveform to be applied is reduced. In contrast, the timing in which the drive voltage waveform generating circuit 110 and the piezo element 204 are connected (the timing shown as “t2” and the timing shown as “t4” in FIG. 5B) is set later. By doing this, since also the expansion and contraction amounts of the piezo element 204 can be reduced by reducing the amplitude of the voltage waveform to be applied (refer to FIG. 3), the size of the ink drop to be ejected can be reduced to thereby eject an ink drop having substantially the same size as ink drops of the other ejection ports 200. By previously setting the gate timing data of each of the ejection ports 200 conforming to the characteristic of the ejection port 200 or the piezo element 204 in this manner, the variations among the plurality of ejection ports 200 can be suppressed to thereby eject ink drops having a uniform size through the ejection ports 200.

In the inkjet printer 10 of the embodiment as described above, the drive voltage waveform generating circuit 110 and the piezo element 204 are temporarily disconnected while the drive voltage waveform generating circuit 110 outputs a drive voltage waveform, whereby a voltage waveform different from the drive voltage waveform output by the drive voltage waveform generating circuit can be applied to the piezo element 204. Therefore, even when a drive voltage waveform output by one drive voltage waveform generating circuit 110 is applied to the plurality of piezo elements 204, a different drive voltage waveform can be applied to each of the piezo elements 204. In addition, by providing the period during which the piezo element 204 and the drive voltage waveform generating circuit 110 are disconnected in the period during which the drive voltage waveform output by the drive voltage waveform generating circuit 110 exceeds a certain voltage and in the period during which the drive voltage waveform falls below a certain voltage, a voltage waveform different in amplitude from the drive voltage waveform output by the drive voltage waveform generating circuit 110 can be applied to the piezo element 204. Thus, by previously setting gate timing data according to the characteristic of each of the ejection ports 200 or the piezo elements 204, the amplitude of the voltage waveform to be applied to the piezo element 204 of each of the ejection ports 200 can be adjusted to suppress variations in the size or the like of ink drops ejected through the ejection ports 200. Thus, by applying the drive voltage waveform generated by one drive voltage waveform generating circuit 110 to the plurality of piezo elements 204, variations in the size of ink drops ejected through the plurality of ejection ports 200 can be suppressed to print a high-quality image while reducing the number of drive voltage waveform generating circuits 110 to keep the device configuration simple.

In the above description, the voltage of the piezo element 204 is held at a certain voltage in the state where the gate element 302 is disconnected (refer to the period from the timing shown as “t1” to the timing shown as “t2” in FIG. 5C). Strictly speaking, however, the electric charge stored in the piezo element 204 is discharged with a lapse of time, and therefore, the voltage of the piezo element 204 decreases little by little with the discharge of the electric charge. Also in this case, however, when the gate element 302 is brought into the conductive state after that, the voltage of the piezo element 204 is immediately recovered with the application of the output voltage of the drive voltage waveform generating circuit 110 to the piezo element 204. Therefore, even when the voltage of the piezo element 204 decreases somewhat, substantially a correct voltage waveform can be applied to the piezo element 204. Accordingly, the piezo element 204 does not need to have such a large electrostatic capacitance as to hold the entire voltage, but may have an electrostatic capacitance with a certain capacity not causing an extreme decrease in voltage.

In the embodiment, the gate timing data is read out and acquired from the ROM of the inkjet printer 10. However, the data may not necessarily be acquired from the ROM of the inkjet printer 10, and may be acquired from other devices. For example, when the inkjet printer 10 is used by connecting to a computer, the data may be acquired from the computer.

In the drive voltage waveform illustrated in FIG. 5A, the voltage continuously changes when increasing or decreasing. However, not only the drive voltage waveform whose voltage continuously changes, but also a drive voltage waveform whose voltage changes stepwise, for example, may be used. Even with such a drive voltage waveform, by manipulating the gate element according to the gate timing data, only parts of the drive voltage waveform can be applied to the piezo element 204. Therefore, a voltage waveform different from the drive voltage waveform can be applied to the piezo element 204. Thus, a proper voltage waveform can be applied to the piezo element 204 of each of the ejection ports 200 to thereby suppress variations in the size or the like of ink drops among the ejection ports 200.

In the state where the drive voltage waveform generating circuit 110 and the piezo element 204 are disconnected, since the voltage of the piezo element 204 is held as described above, the drive voltage waveform generating circuit 110 may not output a voltage during the state. Accordingly, after increasing the voltage, the drive voltage waveform generating circuit 110 may not hold the voltage constant (refer to the voltage shown by the broken lines from the timing shown as “t1” to the timing shown as “t2” in FIG. 5C), but may decrease the voltage. When the timing in which the drive voltage waveform generating circuit 110 and the piezo element 204 are connected again (the timing shown as “t2” in FIG. 5C) is approaching, the voltage may be increased again. Even when the so-called sawtooth type voltage waveform is output, an accurate voltage waveform can be applied to the piezo element 204 because the voltage of the piezo element 204 can be held while the piezo element 204 and the drive voltage waveform generating circuit 110 are disconnected. By doing this, since the period during which the drive voltage waveform generating circuit 110 outputs a voltage can be shortened, it is also possible to reduce the consumption of electric power.

### C. Modified Examples

Hereinafter, modified examples of the embodiment will be described. In the modified examples described below, the same constituents as those in the embodiment are denoted by the same reference numerals and signs as those in the embodiment, and the detailed descriptions thereof are omitted.

### C-1. First Modified Example

In applying a drive voltage waveform to the piezo element 204 for driving, current flows from the drive voltage waveform generating circuit 110 toward the piezo element 204 when the voltage of the piezo element 204 increases; and in contrast, current flows from the piezo element 204 toward the drive voltage waveform generating circuit 110 when the voltage of the piezo element 204 decreases. Between the drive voltage waveform generating circuit 110 and the piezo element 204, therefore, a path in which current directed from the drive voltage waveform generating circuit 110 toward the piezo element 204 flows and a path in which current directed from the piezo element 204 toward the drive voltage waveform generating circuit 110 flows are separately disposed, and a gate element is provided in each of the paths, whereby it is possible to select and flow the current flowing in one of the directions. Using such a configuration makes it possible to apply an accurate drive voltage waveform to the piezo element 204 even when the timing of manipulating the gate element 302 is shifted for some reason as will be described below.

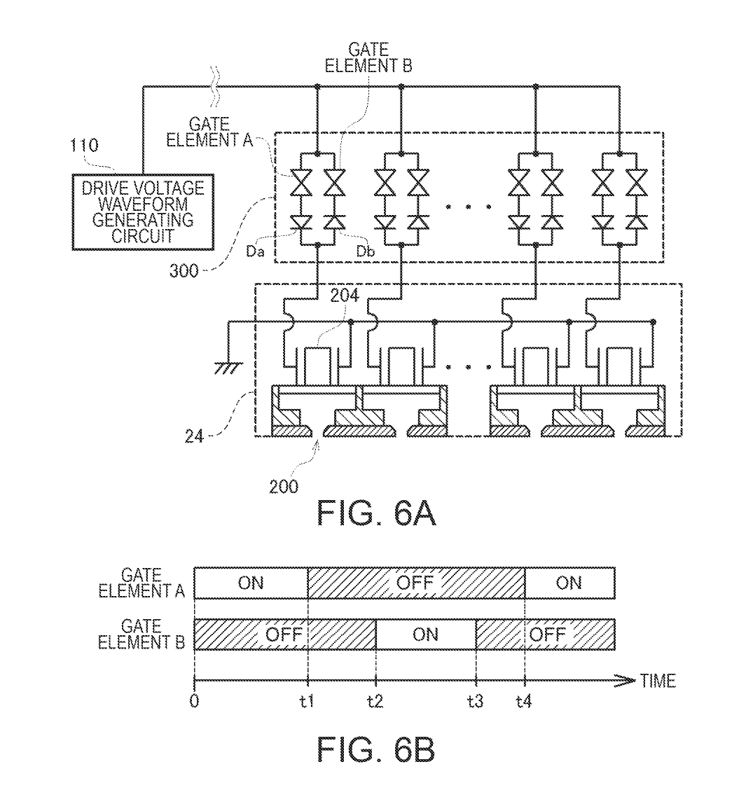

FIGS. 6A and 6B are explanatory diagrams showing a gate unit of a first modified example where the path in which current directed from the drive voltage waveform generating circuit 110 toward the piezo element 204 flows and the path in which current directed from the piezo element 204 toward the drive voltage waveform generating circuit 110 flows are separately disposed. In the gate unit 300 of the modified example as shown in FIG. 6A, each of the piezo elements 204 is connected to the drive voltage waveform generating circuit 110 with two gate elements of a gate element A and a gate element B. A diode Da is connected between the gate element A and the piezo element 204, while a diode Db is connected between the gate element B and the piezo element 204. The diode Da is disposed so as to allow the current in the direction from the side of the drive voltage waveform generating circuit 110 toward the side of the piezo element 204 to flow. Contrary to the diode Da, the diode Db is disposed so as to allow the current in the direction from the side of the piezo element 204 toward the side of the drive voltage waveform generating circuit 110 to flow. Consequently, when the gate element A is brought into the conductive state, it is possible to flow current from the side of the drive voltage waveform generating circuit 110 toward the side of the piezo element 204. In contrast, when the gate element B is brought into the conductive state, it is possible to flow current from the side of the piezo element 204 toward the side of the drive voltage waveform generating circuit 110.

In the inkjet printer 10 of the modified example, corresponding to the two gate elements provided for each of the piezo elements 204, two pieces of gate timing data for the gate element A and for the gate element B are stored on the ROM for each of the ejection ports 200 as shown in FIG. 6B. The inkjet printer 10 of the modified example uses such a configuration to apply a drive voltage waveform to the piezo element 204 as follows.

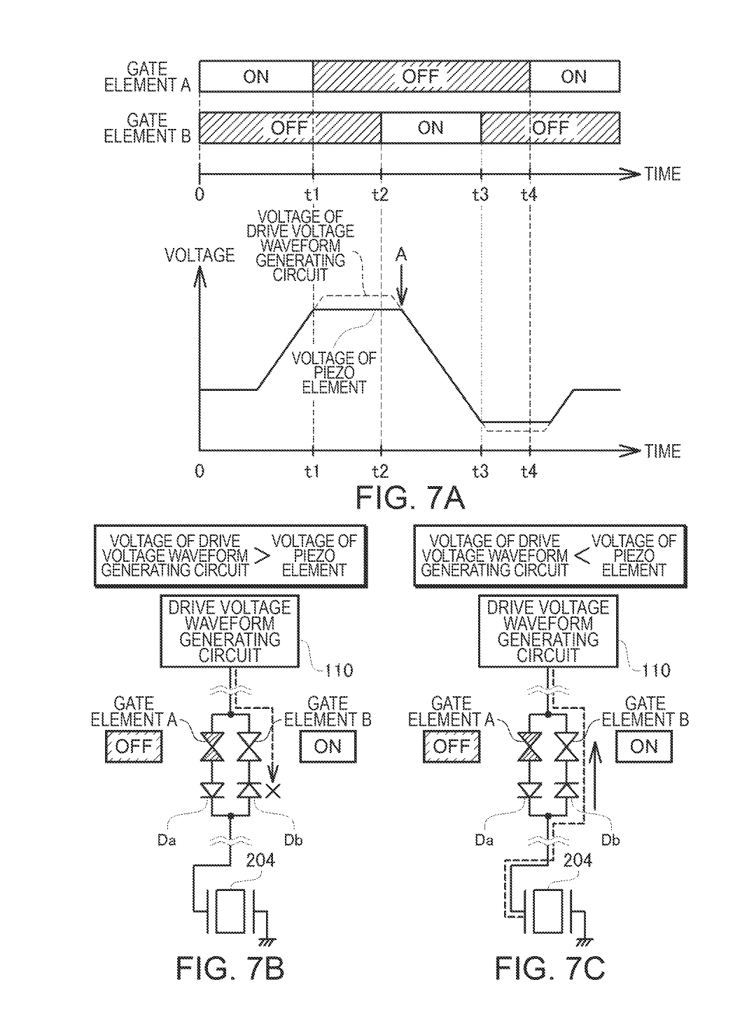

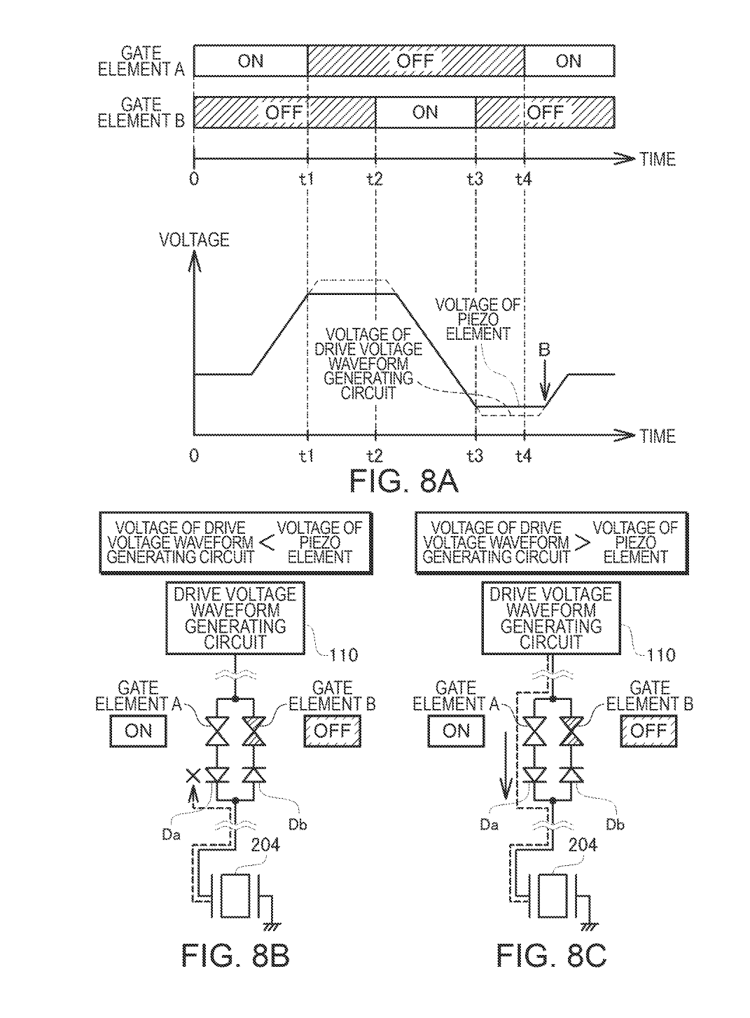

FIGS. 7A to 7C and FIGS. 8A to 8C are explanatory diagrams showing a state of applying a drive voltage waveform to the piezo element using the gate unit of the modified example. On the upper side of FIG. 7A, respective pieces of gate timing data for the gate element A and for the gate element B are shown. On the lower side of FIG. 7A, a voltage to be applied to the piezo element 204 by manipulating the gate elements according to the gate timing data in FIG. 7A is shown.

In applying the drive voltage waveform shown in FIG. 7A, it is necessary to flow current from the drive voltage waveform generating circuit 110 toward the piezo element 204 for increasing the voltage of the piezo element 204. In the gate timing data shown in FIG. 7A, therefore, it is set to bring the gate element A provided in the path from the drive voltage waveform generating circuit 110 toward the piezo element 204 into the conductive state (“ON” state). When the gate element A is brought into the conductive state, it is possible to flow current from the drive voltage waveform generating circuit 110 to the piezo element 204 with an increase in the output voltage (voltage of the drive voltage waveform) of the drive voltage waveform generating circuit 110. As a result, it is possible to cause the voltage of the piezo element 204 to follow the output voltage of the drive voltage waveform generating circuit 110 for increasing. Thereafter, the timing shown as “t1” in the drawing is reached, the gate element A is brought into the disconnection state (“OFF” state) according to the gate timing data. Since the piezo element 204 is a capacitive load as described above, the voltage of the piezo element 204 can be held constant by bringing the gate element A into the disconnection state (refer to the period from the timing shown as “t1” to the timing shown as “t2” in FIG. 7A).

Next, by connecting the drive voltage waveform generating circuit 110 with the piezo element 204, the voltage of the piezo element 204 is decreased. Since flowing current from the piezo element 204 toward the drive voltage waveform generating circuit 110 decreases the voltage of the piezo element 204, the gate element (gate element B) in the path in which the current directed from the piezo element 204 toward the drive voltage waveform generating circuit 110 flows (the path in which the gate element B and the diode Db are connected) is this time bought into the conductive state (“ON” state).

As shown in FIG. 7A in this case, if the timing of manipulating the gate element is shifted for some reason, and the gate element B is brought into the conductive state at a timing earlier than the timing (timing shown as “A” in FIG. 7A) in which the voltage of the drive voltage waveform generating circuit 110 and the voltage of the piezo element 204 coincide with each other (refer to the timing shown as “t2” in FIG. 7A), the gate element B is brought into the conductive state with the voltage of the drive voltage waveform generating circuit 110 being higher than that of the piezo element 204. In the state where there is a difference in voltage between them in this manner, when current flows from the drive voltage waveform generating circuit 110 to the piezo element 204, the voltage of the piezo element 204 may rapidly change. In this regard, in the gate unit 300 of the modified example, the path provided with the gate element B passes the current directed from the piezo element 204 toward the drive voltage waveform generating circuit 110. As shown in FIG. 7B, therefore, even when current attempts to flow from the drive voltage waveform generating circuit 110 with high voltage toward the piezo element 204 with low voltage, the current can be blocked by the diode Db. Consequently, even when the gate element B is brought into the conductive state with the voltage of the drive voltage waveform generating circuit 110 being higher than that of the piezo element 204, the voltage of the piezo element 204 does not change rapidly.

In addition, when the voltage of the drive voltage waveform generating circuit 110 then decreases with a lapse of time, and the voltage of the drive voltage waveform generating circuit 110 becomes lower than that of the piezo element 204, it is possible this time to flow current from the piezo element 204 toward the drive voltage waveform generating circuit 110 as shown in FIG. 7C. Therefore, a voltage waveform can be applied while decreasing the voltage of the piezo element 204 together with the voltage of the drive voltage waveform generating circuit 110. In the inkjet printer 10 of the modified example in this manner, even when the timing of bringing the gate element B into the conductive state is shifted from the timing in which the voltage of the drive voltage waveform generating circuit 110 and the voltage of the piezo element 204 are equal to each other, the voltage of the piezo element 204 does not change rapidly. Further, when the voltage of the drive voltage waveform generating circuit 110 and the voltage of the piezo element 204 become equal to each other, the voltage of the piezo element 204 can be decreased immediately. Accordingly, it is possible to apply an accurate voltage waveform to the piezo element 204 to thereby drive the piezo element 204 accurately.

In the gate unit 300 of the modified example, the possible rapid change in the voltage of the piezo element 204 can be prevented not only when decreasing the voltage of the piezo element 204 but also when increasing the voltage thereof. As shown in FIG. 8A for example, when the gate element A is brought into the conductive state at a timing (timing shown as “t4” in FIG. 8A) earlier than the timing (timing shown as “B” in FIG. 8A) in which the voltage of the drive voltage waveform generating circuit 110 and the voltage of the piezo element 204 become equal to each other, current attempts to flow from the piezo element 204 with high voltage toward the drive voltage waveform generating circuit 110 with low voltage as shown by broken lines in FIG. 8B. However, this current can be blocked by the diode Da. When the output voltage of the drive voltage waveform generating circuit 110 increases with a lapse of time and becomes higher than that of the piezo element 204, the voltage of the piezo element 204 can be increased by flowing current from the drive voltage waveform generating circuit 110 to the piezo element 204 as shown in FIG. 8C. In this manner, even if the timing of bringing the gate element A into the conductive state is shifted, the possible rapid change in the voltage of the piezo element 204 is prevented, and further, the voltage of the piezo element 204 is increased at a proper timing. Therefore, it is possible to apply an accurate voltage waveform to the piezo element 204.

In this manner, the path in which current directed from the drive voltage waveform generating circuit 110 toward the piezo element 204 flows and the path in which current directed from the piezo element 204 toward the drive voltage waveform generating circuit 110 flows are separately disposed, and the gate element is provided in each of the paths, whereby it is possible to select and flow current flowing in one of the directions. As described above, since the voltage of the piezo element 204 increases with current flowing into the piezo element 204 while decreasing with current flowing out of the piezo element 204, the direction (increase or decrease) of change in the voltage of the piezo element 204 can be controlled by controlling the direction of current as described above. This makes it possible to prevent the voltage of the piezo element 204 from changing in the opposite direction from a desired direction of change in the voltage of the piezo element 204. As a result, the voltage of the piezo element 204 can be accurately controlled to thereby apply an accurate voltage waveform.

### C-2. Second Modified Example

In the gate unit 300 of the first modified example as described above, even when the gate element is brought into the conductive state earlier than the timing in which the voltage of the drive voltage waveform generating circuit 110 and the voltage of the piezo element 204 coincide with each other, current can be blocked until the voltage of the drive voltage waveform generating circuit 110 and the voltage of the piezo element 204 coincide with each other. In addition, it is possible to allow current to start flowing at an accurate timing in which the voltage of the drive voltage waveform generating circuit 110 and the voltage of the piezo element 204 coincide with each other. Therefore, when the gate element is brought into the conductive state, the gate element may not be brought into the conductive state at the timing in which the voltage of the drive voltage waveform generating circuit 110 and the voltage of the piezo element 204 coincide with each other, but may be brought into the conductive state intentionally earlier than the timing. By doing this, since it is possible to prevent current from flowing until the voltage of the drive voltage waveform generating circuit 110 and the voltage of the piezo element 204 coincide with each other and to flow current from the drive voltage waveform generating circuit 110 toward the piezo element 204 at the timing in which their voltages coincide with each other, an accurate voltage waveform can be reliably applied to the piezo element 204. By previously setting the timing of bringing the gate element into the conductive state earlier, even when the actual timing of bringing the gate element into the conductive state is somewhat later than the set timing, it is possible to flow current at a proper timing to thereby apply an accurate voltage waveform to the piezo element 204 because there is time until the current actually starts flowing.

### C-3. Third Modified Example

In the gate unit 300 of the first modified example, the gate element A and the gate element B are manipulated independently of each other. However, both the gate element A and the gate element B may be manipulated, and further, the so-called exclusive manipulation may be performed in which the gate element B is brought into the disconnection state when the gate element A is brought into the conductive state, while the gate element B is brought into the conductive state when the gate element A is brought into the disconnection state.

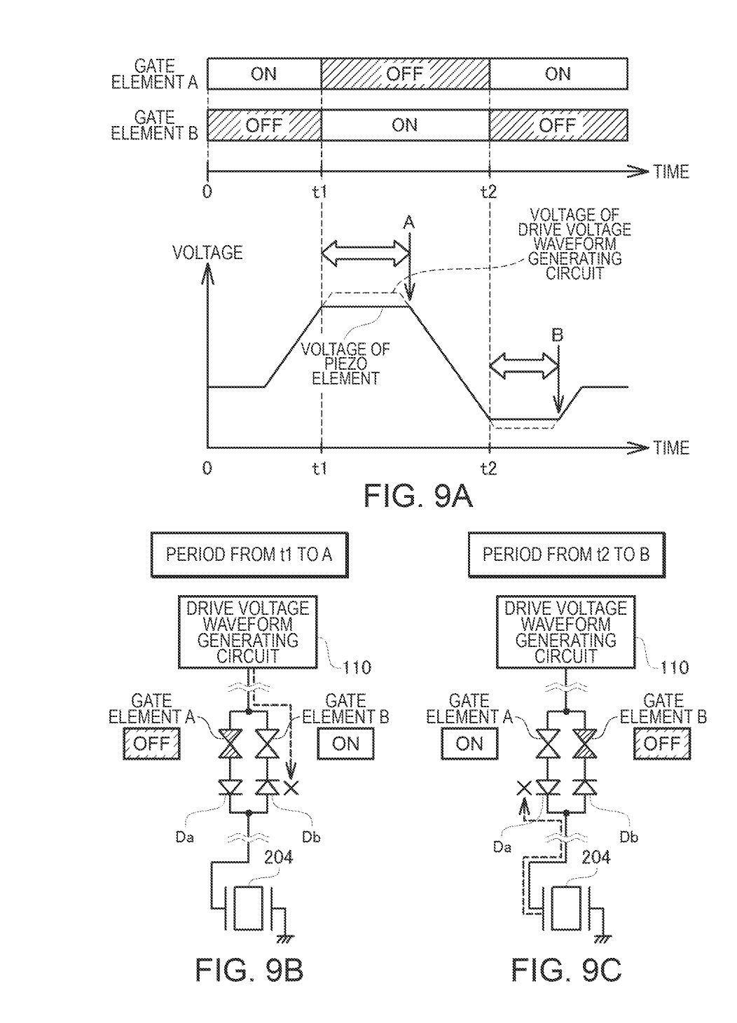

FIGS. 9A to 9C are explanatory diagrams showing a state of applying a voltage waveform to the piezo element using a gate unit of a third modified example where two gate elements are exclusively manipulated. As shown in FIG. 9A, in gate timing data used in the gate unit of the third modified example, it is set to perform the so-called exclusive manipulation in which the gate element B is brought into the “OFF” state when the gate element A is brought into the “ON” state, while the gate element B is brought into the “ON” state when the gate element A is brought into the “OFF” state. In applying a drive voltage waveform to the piezo element 204 using such gate timing data, the gate element (gate element A) in the path in which current directed from the drive voltage waveform generating circuit 110 toward the piezo element 204 flows is first brought into the conductive state (“ON” state), similarly to the first modified example. Thus, since the current flows from the drive voltage waveform generating circuit 110 toward the piezo element 204, the voltage of the piezo element 204 can be increased with the output voltage of the drive voltage waveform generating circuit 110. Next, when the timing shown as “t1” in FIG. 9A is reached, the gate element A is brought into the disconnection state according to the gate timing data.

In the third modified example in this case, the gate element A and the gate element B are exclusively manipulated. Therefore, for bringing the gate element A into the disconnection state, the gate element B is brought into the conductive state instead. Consequently, even in the period (period from the timing shown as “t1” to the timing shown as “A” in the graph in FIG. 9A) during which the voltage of the drive voltage waveform generating circuit 110 is not applied to the piezo element 204, one of the gate elements (the gate element B) is not brought into the disconnection state but brought into the conductive state. However, even when the gate element B is in the conductive state, the voltage of the drive voltage waveform generating circuit 110 is higher than that of the piezo element 204 until the voltage of the drive voltage waveform generating circuit 110 and the voltage of the piezo element 204 coincide with each other (refer to the period from the timing shown as “t1” to the timing shown as “A” in FIG. 9A). As shown in FIG. 9B, therefore, current can be blocked by the diode Db. Consequently, even when one of the gate elements (the gate element B) is in the conductive state, the voltage of the piezo element 204 can be held constant by preventing current from flowing between the piezo element 204 and the drive voltage waveform generating circuit 110.

After the timing (timing shown as “A” in FIG. 9A) in which the voltage of the drive voltage waveform generating circuit 110 and the voltage of the piezo element 204 coincide with each other is reached, it is possible to flow current from the piezo element 204 toward the drive voltage waveform generating circuit 110 as described above, thereby making it possible to decrease the voltage of the piezo element 204 at a proper timing to apply an accurate voltage waveform.

When the timing shown as “t2” in FIG. 9A is reached, the gate element B is this time brought from the conductive state into the disconnection state, and the gate element A is brought into the conductive state instead. Also in this case, even though the voltage of the drive voltage waveform generating circuit 110 is not applied to the piezo element 204, one of the gate elements (the gate element A) is brought into the conductive state. This time, however, current can be blocked by the diode Da until the voltage of the drive voltage waveform generating circuit 110 and the voltage of the piezo element 204 coincide with each other (the period from the timing shown as “t2” to the timing shown as “B” in FIG. 9A) as shown in FIG. 9C. Thus, the voltage of the piezo element 204 can be held constant. After the voltage of the drive voltage waveform generating circuit 110 and the voltage of the piezo element 204 coincide with each other (refer to the timing shown as “B” in FIG. 9A), since it is possible to flow current from the drive voltage waveform generating circuit 110 to the piezo element 204 via the diode Da, the voltage waveform can be applied to the piezo element 204 while increasing the voltage of the piezo element 204.

In this manner, when the path (path in which the gate element A and the diode Da are connected) in which the current directed from the drive voltage waveform generating circuit 110 toward the piezo element 204 flows and the path (path in which the gate element B and the diode Db are connected) in which the current directed in the opposite direction from the above are disposed, current flowing in one of the paths flows in the opposite direction from the other path. Therefore, when the gate element (for example, the gate element A) in one of the paths is brought into the disconnection state, even though the gate element (for example, the gate element B) in the other path is brought into the conductive state, current does not flow because the current flows in the opposite direction from the other path. Therefore, by bringing one of the gate elements into the disconnection state and bringing the other gate element into the conductive state, current can be blocked to thereby hold the voltage of the piezo element 204 constant until the current changes in direction (until the voltage of the drive voltage waveform generating circuit 110 and the voltage of the piezo element 204 coincide with each other). Since the current changes in direction after the voltage of the drive voltage waveform generating circuit 110 and the voltage of the piezo element 204 coincide with each other, it is possible to flow current between the drive voltage waveform generating circuit 110 and the piezo element 204. Thus, by flowing current between the drive voltage waveform generating circuit 110 and the piezo element 204 at a proper timing, an accurate voltage waveform can be applied to the piezo element 204.

In the so-called exclusive manipulation, if there is gate timing data for one of the gate elements, the other gate element can also be manipulated according to the gate timing data. Therefore, respective pieces of gate timing data of the gate elements are not necessarily required, and the gate timing data for one of the gate elements may suffice. Using the gate timing data for one of the gate elements makes it possible to save the storage capacity of the ROM for storing gate timing data, and therefore, a time required for the gate element control circuit 150 to acquire gate timing data can be shortened.

In applying the voltage of the drive voltage waveform generating circuit 110 to the piezo element 204 in the gate unit 300 of the third modified example, after the timing (timing shown as “A” and timing shown as “B” in FIG. 9A) in which the voltage of the drive voltage waveform generating circuit 110 and the voltage of the piezo element 204 become equal to each other has passed, the direction of current is reversed, and current starts flowing naturally. At this timing, therefore, the gate element may not be manipulated. Accordingly, the number of manipulations of the gate element can be reduced, and further, the configuration of the gate element control circuit 150 that manipulates the gate element can be simplified. It is also possible to reduce the data amount of gate timing data.

### C-4. Fourth Modified Example

In the embodiment and modified examples, the gate element is manipulated according to the gate timing data describing the timing of manipulating the gate element. However, the gate element may be manipulated according to data describing not the timing of manipulating the gate element but the voltage of the drive voltage waveform generating circuit 110 at the timing of manipulating the gate element.

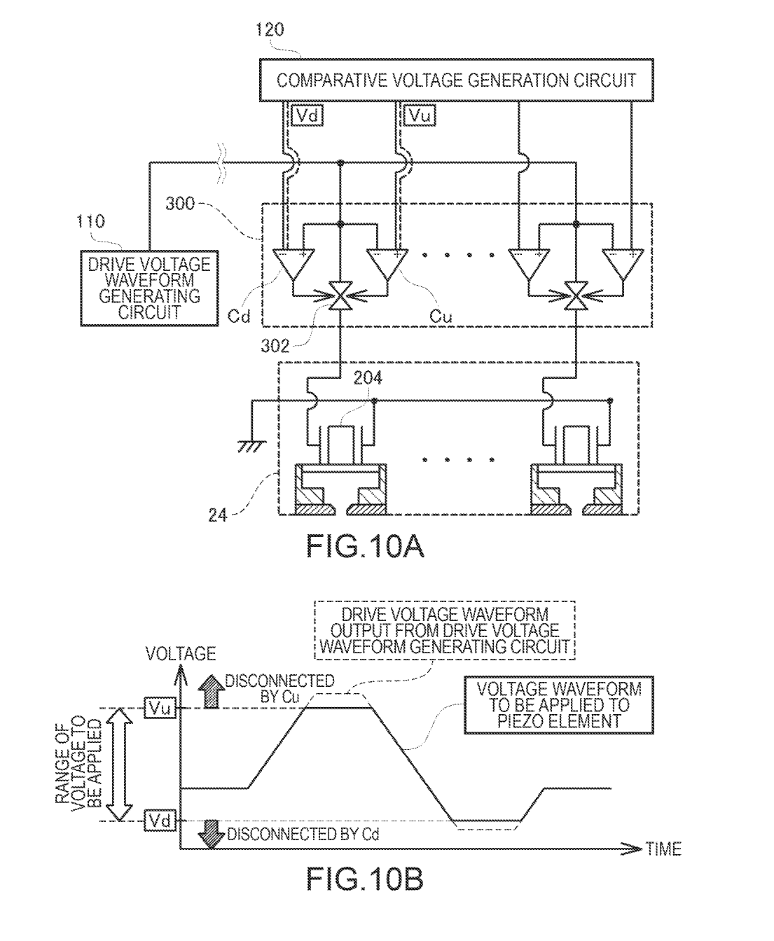

FIGS. 10A and 10B are explanatory diagrams showing the gate unit 300 of a fourth modified example where the gate element is manipulated according to data describing the output voltage of a drive voltage waveform when manipulating the gate element. In the gate unit 300 of the fourth modified example as shown in FIG. 10A, two comparators (voltage comparators) of a comparator Cd and a comparator Cu are connected to each of the gate elements 302. Even using these comparators, in addition to the gate element control circuit 150, makes it possible to manipulate the gate element 302. The comparator Cd and the comparator Cu are connected to a comparative voltage generation circuit 120, and the output voltage of the comparative voltage generation circuit 120 and the output voltage of the drive voltage waveform generating circuit 110 can be compared.

In the inkjet printer 10 of the fourth modified example in this case, two voltage values of an “upper limit voltage value” and a “lower limit voltage value” are previously stored on the ROM of the printer control circuit 50 (refer to FIG. 4) in association with each of the ejection ports 200. After the printer control circuit 50 determines the ejection port 200 through which an ink drop is to be ejected based on image data to be printed, the comparative voltage generation circuit 120 acquires the upper limit voltage value and the lower limit voltage value corresponding to the ejection port 200, outputs the lower limit voltage value (voltage value “Vd” in the example in FIG. 10A) from a terminal to which the comparator Cd is connected, and outputs the upper limit voltage value (voltage value “Vu” in the example in FIG. 10A) from a terminal to which the comparator Cu is connected.

By doing this, since the comparator Cu can compare the output voltage of the drive voltage waveform generating circuit 110 with the upper limit voltage value “Vu”, the comparator Cu can bring the gate element 302 into the disconnection state when the output voltage of the drive voltage waveform generating circuit 110 exceeds the upper limit voltage value. On the other hand, since the comparator Cd can compare the output voltage of the drive voltage waveform generating circuit 110 with the lower limit voltage value “Vd”, the comparator Cd can bring the gate element 302 into the disconnection state when the output voltage of the drive voltage waveform generating circuit 110 falls below the lower limit voltage value “Vd”. Thus as shown in FIG. 10B, when the voltage of the drive voltage waveform is higher than the upper limit voltage value “Vu”, the gate element 302 is disconnected by the comparator Cu. On the other hand, when the voltage of the drive voltage waveform is lower than the lower limit voltage value “Vd”, the gate element 302 is disconnected by the comparator Cd. Accordingly, while the voltage of the drive voltage waveform lies between the upper limit voltage value “Vu” and the lower limit voltage value “Vd”, the drive voltage waveform can be applied to the piezo element. As a result as shown in FIG. 10B, a voltage waveform different in amplitude from the drive voltage waveform output by the drive voltage waveform generating circuit 110 can be applied to the piezo element 204.

In this manner, when the output voltage of the drive voltage waveform generating circuit 110 is higher than the upper limit voltage value or lower than the lower limit voltage value, by disconnecting the drive voltage waveform generating circuit 110 from the piezo element 204, a voltage higher than the upper limit voltage value or a voltage lower than the lower limit voltage value is not applied. As a result, a voltage waveform whose amplitude is smaller than that of the drive voltage waveform can be applied to the piezo element 204. Therefore, by previously determining the upper limit voltage value and the lower limit voltage value for each of the ejection ports 200, a voltage waveform having a proper amplitude according to the characteristic of each of the ejection ports 200 can be applied to the piezo element 204 of each of the ejection ports 200, making it possible to suppress variations in the size of ink drops caused by the characteristics of the ejection ports 200 and to eject ink drops having a uniform size.

Further in the gate unit 300 of the fourth modified example, when the voltage of the drive voltage waveform generating circuit 110 exceeds the upper limit voltage value or falls below the lower limit voltage value, the gate element 302 is immediately disconnected by the comparator Cu or the comparator Cd. Since the gate element control circuit 150 does not have to manipulate the gate element 302 at correct timings, it is possible to simplify the configuration of the gate element control circuit 150 to thereby simplify the device configuration of the inkjet printer 10.

### C-5. Fifth Modified Example

In the inkjet printer 10 of the embodiment and modified examples, the gate element 302 of the ejection port 200 through which an ink drop is to be ejected is manipulated based on the gate timing data (or the upper limit voltage value and the lower limit voltage value) of the ejection port 200. However, not only for the ejection port 200 through which an ink drop is to be ejected but also for the ejection port 200 through which an ink drop is not to be ejected, the gate element may be manipulated based on the gate timing data (or the upper limit voltage value and the lower limit voltage value).

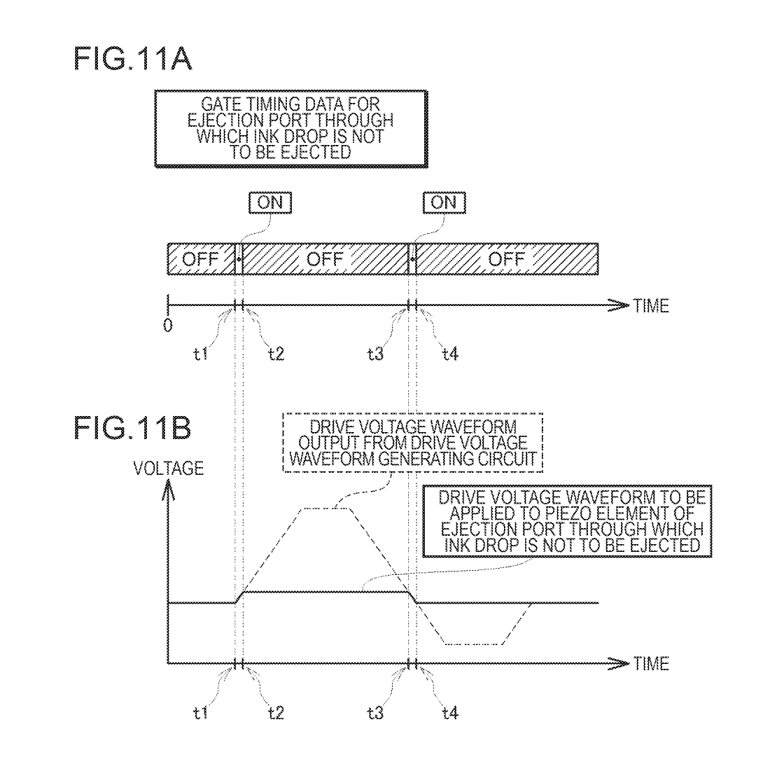

FIGS. 11A and 11B are explanatory diagrams illustrating a state of manipulating, according to gate timing data, the gate element of an ejection port through which an ink drop is not to be ejected. FIG. 11A illustrates gate timing data for the ejection port through which an ink drop is not to be ejected. In the ejection port 200, since ink in the ink chamber 202 is exposed to the air at the opening of the ejection port 200 (refer to FIG. 2), ink in the vicinity of the opening dries little by little while the ink drop is not ejected, sometimes resulting in an increase in the viscosity of the ink (thickening). Consequently, in the ejection port 200 through which an ink drop is not to be ejected, it is preferable to slightly move the piezo element to vibrate the ink in the ink chamber, thereby suppressing thickening of the ink. In view of this, in the gate timing data for the ejection port through which an ink drop is not to be ejected as shown in FIG. 11A, it is set to bring the gate element into the conductive state (“ON” state) only in a small amount of time (refer to the period from the timing shown as “t1” to the timing shown as “t2” and the period from the timing shown as “t3” to the timing shown as “t4” in FIG. 11A).

Manipulating the gate element according to such gate timing data makes it possible to apply a voltage waveform whose voltage slightly varies to the piezo element 204 in response to the gate element that is brought into the conductive state only in a small amount of time as shown in FIG. 11B. Therefore, by slightly moving the piezo element 204 to vibrate the ink in the ink chamber 202, thickening of the ink can be suppressed. By doing this, also for the ejection port 200 through which an ink drop is not to be ejected, gate timing data is acquired to manipulate the gate element similarly to the ejection port 200 through which an ink drop is to be ejected, whereby a proper voltage waveform can be applied to the piezo element 204. Therefore, the ejection port 200 through which an ink drop is not to be ejected is not treated differently from the ejection port 200 through which an ink drop is to be ejected, and a voltage waveform can be applied to any of the ejection ports 200 in the same way. Accordingly, since there is no need to provide a process for separately generating a drive voltage waveform dedicated for driving the piezo element 204 of the ejection port 200 through which an ink drop is not to be ejected, processes in the drive voltage waveform generating circuit 110 or the printer control circuit 50 can be simplified. Since there is also no need to provide a circuit dedicated for generating the voltage waveform of the ejection port 200 through which an ink drop is not to be ejected, the circuit configuration of the piezo element driving circuit 100 can also be simplified. In addition, since one drive voltage waveform can drive the piezo element 204 of the ejection port 200 through which an ink drop is to be ejected and the piezo element 204 of the ejection port 200 through which an ink drop is not to be ejected, there is no need to separately provide a time for applying a voltage waveform to the piezo element 204 of the ejection port 200 through which an ink drop is not to be ejected. Therefore, it is possible to shorten a time required for printing an image to thereby print an image at high speed.

Instead of acquiring gate timing data, the upper limit voltage value and the lower limit voltage value may be acquired similarly to the fourth embodiment (refer to FIGS. 10A and 10B), and a drive voltage waveform may be applied to the ejection port 200 through which an ink drop is not to be ejected only in the period during which the voltage of the drive voltage waveform lies between the upper limit voltage value and the lower limit voltage value. Also in this case, by previously setting the upper limit voltage value and the lower limit voltage value so that the difference between the upper limit voltage value and the lower limit voltage value becomes small, a voltage waveform whose amplitude is small can be applied to the piezo element 204 of the ejection port 200 through which an ink drop is not to be ejected. Therefore, it is possible to slightly move the piezo element 204 to thereby suppress thickening of the ink in the ejection port 200. Also in this case, since it is of course possible to drive the ejection port 200 through which an ink drop is to be ejected and the ejection port 200 through which an ink drop is not to be ejected in the same way without treating them differently, the circuit configuration of the printer control circuit 50 or the piezo element driving circuit 100 can be kept simple.

The inkjet printer on which the piezo element driving circuit of the embodiment is mounted has been described. However, the invention is not limited to all the embodiment and modified examples, but can be implemented in various aspects within a range not departing from the gist thereof. For example, the piezo element driving circuit of the embodiment may be mounted on a printer provided with a larger ejection head (so-called line head printer etc.). In such a printer, since a large number of ejection ports are disposed along with an increase in the size of the ejection head, it is more difficult to equalize the characteristics of the ejection ports. In view of this, however, using the piezo element driving circuit of the embodiment makes it possible to apply a proper voltage waveform conforming to the characteristic of each of the ejection ports. Therefore, variations in the size of ink drops ejected through the ejection ports can be suppressed to print a high-quality image.

In the embodiment, an example in which the piezo element of the inkjet printer is driven has been described. However, the driving circuit of the embodiment is applicable to various devices driven according to a voltage. For example, the driving circuit of the embodiment is applicable to display devices, such as liquid crystal panels or organic EL panels, operable by a voltage. Also in driving such devices, it is possible to apply a proper voltage waveform to each of various elements such as liquid crystal elements or organic EL elements to thereby suppress variations in the operation of the elements.

This application claims priority to Japanese Patent Application No. 2009-269669, filed on Nov. 27, 2009, the entirety of which is hereby incorporated by reference.

What is claimed is:

1. A capacitive load driving circuit comprising:
a voltage waveform output unit that outputs a voltage waveform used for driving a plurality of capacitive loads; and
a voltage waveform applying unit that connects each of the plurality of capacitive loads to output of the voltage waveform output unit to thereby apply the voltage waveform to each of the plurality of capacitive loads, wherein
the voltage waveform applying unit releases a connection between the capacitive load and the output of the voltage waveform output unit when voltage of the voltage waveform falls outside a voltage range determined for each of the plurality of capacitive loads, and connects the capacitive load to the output of the voltage waveform output unit when the voltage of the voltage waveform falls within the voltage range, to thereby apply a different voltage waveform to each of the plurality of capacitive loads.

2. The capacitive load driving circuit according to claim 1, wherein
the voltage waveform applying unit connects the capacitive load to the output of the voltage waveform output unit via a rectifying element connected to the capacitive load in a direction in which current is blocked from flowing into the capacitive load when the voltage of the voltage waveform becomes higher after releasing the connection of the capacitive load than that of before releasing the connection of the capacitive load, and connects the capacitive load to the output of the voltage waveform output unit via the rectifying element connected in a direction in which current is blocked from flowing out of the capacitive load when the voltage of the voltage waveform becomes lower after releasing the connection of the capacitive load than that of before releasing the connection of the capacitive load.

3. A capacitive load driving circuit comprising:
a voltage waveform output unit that outputs a voltage waveform used for driving a first capacitive load and a second capacitive load; and
a voltage waveform applying unit that applies the voltage waveform to the first capacitive load and the second capacitive load, wherein
the voltage waveform applying unit releases the connection between the first capacitive load and output of the voltage waveform output unit when voltage of the voltage waveform falls outside a first voltage range determined for the first capacitive load, and connects the first capacitive load to the output of the voltage waveform output unit when the voltage of the voltage waveform falls within the first voltage range, while releasing the connection between the second capacitive load and the output of the voltage waveform output unit when the voltage of the voltage waveform falls outside a second voltage range determined for the second capacitive load and at least a part of which is different from the first voltage range, and connecting the second capacitive load to the output of the voltage waveform output unit when the voltage of the voltage waveform falls within the second voltage range, to thereby apply a different voltage waveform to each of the first capacitive load and the second capacitive load.

4. A fluid ejection device comprising:
the capacitive load driving circuit according to claim 1;
an ejection nozzle through which fluid is ejected; and
an actuator that is connected to the capacitive load driving circuit as the capacitive load and driven by the capacitive load driving circuit to thereby cause the fluid to be ejected through the ejection nozzle.
